(19) United States
(12) Patent Application Publication
(10) Pub. No.: US 2015/0260127 A1
(43) Pub. Date: Sep. 17, 2015

(54) Aircraft Turbofan Engine with Multiple High-Pressure Core Modules Not Concentric with the Engine Centerline

(71) Applicant: Arthur J. Wennerstrom, Henderson, NV (US)

(72) Inventor: Arthur J. Wennerstrom, Henderson, NV (US)

(21) Appl. No.: 14/209,679

(22) Filed: Mar. 13, 2014

(51) Int. Cl. F02K 3/075; F02K 3/115

(52) U.S. Cl. CPC F02K 3/075; F02K 3/115; F05D 2260/211; F05D 2260/606

(57) ABSTRACT

An aircraft turbofan engine configuration is described that has two or more high-pressure core modules operating in parallel flowpaths, each comprised of a compressor, a combustor, and a turbine, the axes of which are adjacent to but removed from the engine axis, in lieu of a single high-pressure core serving the same purpose that is coaxial with the engine axis in prior-art designs. An intercooler is included between the low-pressure compressor and the high-pressure compressor that differs from prior-art designs by being made an integral part of the fan stator rather than inserted as a separate entity. Both features offer advantages relative to prior-art designs.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, ETC.

Not Applicable

### BACKGROUND OF THE INVENTION

This invention pertains to aircraft engines defined as turbofans. A turbofan is distinguished from other aircraft turbine engines in that the air entering the engine is divided into two streams after passing through one or more compressor stages comprising the fan. The radially outermost stream of air bypasses the rest of the engine and is discharged to the free stream. The radially innermost stream of air passes through additional stages of compression, then through a combustor within which its temperature is greatly increased, and finally through one or more turbine stages that provide the power to drive the fan and following compressor stages as well as providing power for auxiliary devices and electrical needs. Air leaving the last turbine stage is then discharged to the free stream where it mixes with the flow that has passed through the fan.

Prior art aircraft turbofans have two or three spools connected in series. A spool is considered to be one or a group of fan and/or compressor stages driven by a particular turbine, which also may contain one or more stages. Connection in series means that all of the flow leaving the first spool passes through the second spool, all of the flow leaving the second spool passes through the third spool, etc., neglecting minor bleed flows that may leave or re-enter the flowpath at any point. Sometimes a spool includes gearing that allows the fan to rotate at a slower speed than its drive turbine. The prior art design of large turbofans requires all spools to be located along the engine centerline so that the shafts connecting each turbine with its fan and/or compressor are concentric with one another. This patent is primarily aimed at alleviating performance limitations caused by excessive tip clearance in the last few compressor stages of turbofans operating at engine cycle pressure ratios above 50:1. A secondary objective is to enhance the reliability, safety and maintainability of the engine as described in the second paragraph of the “brief summary of the invention”.

Maximum engine cycle pressure ratio is defined as the ratio of the highest static pressure found in the engine air stream divided by the engine inlet static pressure at the same operating condition. This ratio is now approaching 60:1. Theoretically, still further increases in cycle pressure ratio could increase cycle efficiency, thereby decreasing engine fuel consumption, but there are practical limitations associated with prior art design that seriously limit the potential for further increases. Air pressure increases as it passes through succeeding compressor stages, causing the air to become increasingly dense. The cross-sectional area of the flowpath must progressively decrease in order to maintain reasonable flow velocity through the passages. In an engine constructed with concentric spools, the radius of the flowpath cannot be decreased beyond certain limits because of mechanical constraints and because the circumferential speed of both compressor and turbine blading must remain high in order to do the work required. Thus, the flow annulus width becomes increasingly narrow as the pressure is increased. The net result is that prior-art design results in compressor blades in the stages operating at highest pressure having a very small radial span in relation to the running clearance required to prevent the blade tips from contacting the casing. As the ratio of running clearance to blade span becomes larger, compressor efficiency decreases rapidly resulting in lower engine efficiency, higher fuel consumption, and decreased stall margin. Therefore, with prior art designs, all spools of which are concentric, it has been extremely difficult to achieve a cycle pressure ratio of 60:1 with acceptable performance and it is very unlikely that economical designs with good performance will be achievable at higher cycle pressure ratios.

### BRIEF SUMMARY OF THE INVENTION

This invention is primarily intended to allow engine cycle pressure ratios to be increased beyond prior art into the range of 60:1 to 120:1. It achieves this objective through two significant design changes. First, intercooling is included between the low-pressure compressor and the high-pressure compressor by passing the air through passages in the fan stator. The concept of intercooling is not new but integrating the intercooler with the fan stator is new. Second, that portion of the turbomachinery operating at highest pressure which normally coaxially follows the low-pressure compressor along the engine axis is replaced with two or more high-pressure core modules the flow through which is connected in parallel and the axes of which are positioned around the engine axis and some distance from it. Connected in parallel means that the flow from the upstream low-pressure spool is divided between however many high-pressure core modules are located downstream in the flow path. In this manner, the compressor and turbine blading in these modules can pass the necessary mass flow and, at the same time, be designed with small clearance-to-span ratios capable of allowing high efficiency.

The construction described by this invention offers four additional advantages for cycle pressure ratios both above and below 60:1. First, the high-pressure core, which includes the engine combustor(s) and which experiences the highest engine temperatures, is that portion of any turbine engine most subject to failure, whether due to natural causes or foreign-object damage. An engine with multiple high-pressure core modules can potentially keep operating at reduced thrust if only one module, or a small portion of the modules fail; a safety feature. Second, with a motor/generator attached to each core module, additional electrical redundancy is provided; another safety feature. Third, high-pressure core modules not concentric with the engine axis can be replaced without dismantling the entire engine, possibly even without removing the engine from the aircraft; a major maintenance advantage. Fourth, with intercooling included between the low-pressure compressor and the high-pressure core modules, this design approach permits peak engine temperatures to be lowered, allowing a highly efficient engine to be constructed using materials with lower temperature capability.

### BRIEF DESCRIPTION OF THE SEVERAL VIEWS OF THE DRAWING

FIG. 1 is a schematic cross-sectional drawing of a turbofan engine viewed from above, illustrating the arrangement of the major parts of an engine designed according to this invention.

FIG. 2 is a schematic sectional view looking along the engine axis from the front and further illustrates the location of the high-pressure core modules in relation to the engine axis. These figures show only two high-pressure core modules for simplicity. When only two are used, it was assumed that they would be placed one on each side for easy maintenance access. However, this patent envisions a minimum of two such modules and rarely more than six, all of which could be located around the axis of the engine in whatever pattern suits the specific application best. The optimum number of modules is expected to vary depending upon engine size, bypass ratio, and possibly other parameters or requirements.

### DETAILED DESCRIPTION OF THE INVENTION

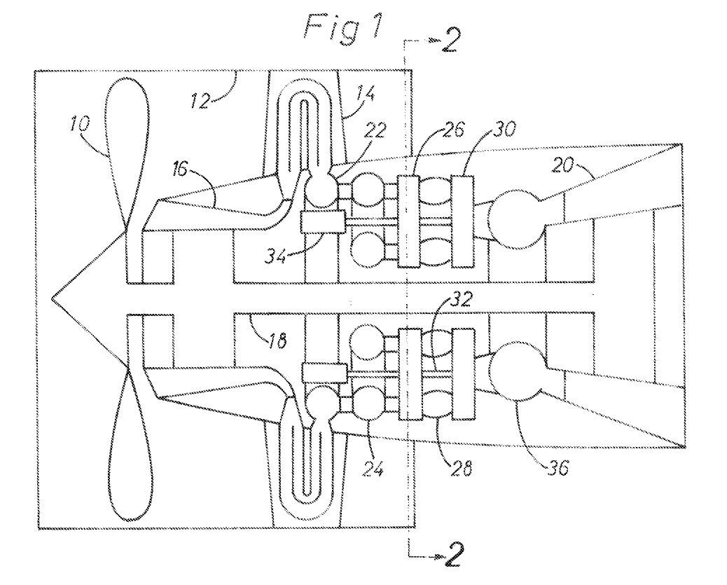

Reference is now made to FIG. 1 of the drawing that shows a schematic cross section of a turbofan aircraft engine incorporating the invention. Air entering the engine first passes through fan rotor 10 comprised of a multiplicity of rotating airfoil blades and is contained within fan casing 12. Most of the air termed the bypass flow continues through fan stator 14 comprised of a multiplicity of stationary airfoil blades and then exits the engine.

The remainder of the flow that passed through fan rotor 10 is termed the core flow and enters low-pressure compressor 16 within which its pressure and temperature are substantially increased. Low-pressure compressor 16 can be of axial or radial design or a combination of both. Power to the fan and low-pressure compressor rotors is conveyed along the axis of the engine via path 18 from turbine 20. Turbine 20 may consist of a single turbine driving both the fan and low-pressure compressor or separate turbines, one driving the fan and a second driving the low-pressure compressor. Gearing may be included to allow fan rotor 10 to operate at a lower speed than turbine 20. Everything mentioned up to this point is prior art.

The features unique to this invention begin here. Fan stator 14 contains internal passages within each blade allowing it to act as a heat exchanger termed the intercooler. High-pressure, high-temperature air leaving low-pressure compressor 16 passes through the internal passages of fan stator 14, transferring heat from the core flow to the bypass flow. The now cooler core flow exits fan stator 14 and enters manifold 22 that surrounds the axis of the engine.

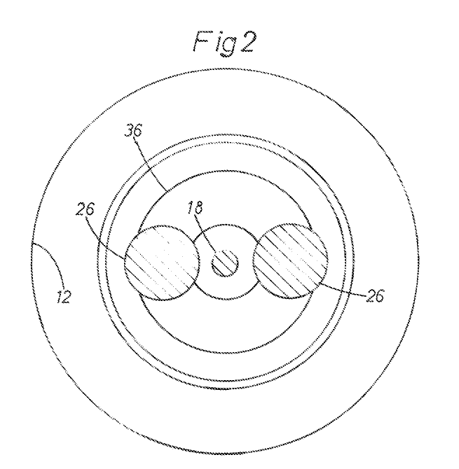

Manifold 22 then distributes the core flow to two or more core power modules, each consisting of a compressor 26, a combustor 28, and a turbine 30, that are not co-axial with the engine axis but are removed from that axis as shown in FIG. 1 & FIG. 2 of the drawing. The compressor and turbine of each core power module can be of axial or radial design or any combination of both. Each core power module consists of an inlet collector 24 providing a uniform inflow to the module's compressor 26 from which flow enters the combustor 28 and passes through turbine 30 that provides the power required to drive compressor 26 through driveshaft 32.

A combined electrical starter/generator 34 is also connected to driveshaft 32 that allows starting of the engine and also provides electrical power during operation using excess power from turbine 30. Flow leaving the core modules enters collector 36 surrounding the engine from which it passes through turbine 20 and exits the engine.

I claim:

1. An intercooled aircraft turbofan engine construction in which the fan stator blades function as the intercooler by containing internal flow passages through which air leaving the low-pressure compressor is passed on its way to the high-pressure compressor.

2. An intercooled aircraft turbofan engine construction as in claim 1 in which the prior-art single high-pressure spool (typically consisting of a compressor, one or more combustors, and a drive turbine, all concentric with the engine axis) is replaced with two or more high-pressure modules (each consisting of a compressor, a combustor, and a drive turbine) that divide the flow, that would have previously passed through the prior-art single high-pressure spool, into multiple parallel paths the axes of which surround the engine axis at some distance radially removed from it.

3. An intercooled aircraft turbofan engine construction as in claim 2 in which each high-pressure module incorporates a coaxial electric motor/generator used to start each module and to provide electrical power for engine and aircraft systems during operation.
